(19) United States
(12) Patent Application Publication
(10) Pub. No.: US 2024/0033880 A1
(43) Pub. Date: Feb. 1, 2024

(54) GRINDING AID PARTICLES FOR ABRASIVE ARTICLES

(71) Applicant: 3M INNOVATIVE PROPERTIES COMPANY, St. Paul, MN (US)

(72) Inventors: Adam D. Miller, Vadnais Heights, MN (US); Joseph B. Eckel, Vadnais Heights, MN (US); Ann M. Hawkins, Lake Elmo, MN (US); Thomas J. Nelson, Woodbury, MN (US); Junting Li, Shanghai (CN); Mark A. Lukowski, St. Paul, MN (US)

(21) Appl. No.: 18/256,947

(22) PCT Filed: Nov. 30, 2021
(86) PCT No.: PCT/IB2021/061138

§ 371 Date: Jun. 12, 2023

Related U.S. Application Data
(60) Provisional application No. 63/199,334, filed on Dec. 21, 2020.

(51) Int. Cl. B24D 18/00; B24D 11/00; B24D 3/34; C09K 3/14

(52) U.S. Cl. CPC B24D 18/0072; B24D 11/001; B24D 3/342; C09K 3/1409

(57) ABSTRACT

Grinding aid particles for abrasive articles. The grinding aid particles include a core particle having a Mohs hardness of less than 7 and a coating on at least a portion of the surface of the core. The coating comprises a binder and at least one grinding agent. The grinding aid particles can be incorporated in the make coat, size coat and/or supersize coat of an abrasive article to improve abrasive performance.

### FIELD OF INVENTION

The present invention relates to grinding aids for abrasive articles, and more particularly to grinding aid particles. The invention further relates to abrasive articles containing the grinding aid particles and methods for making the abrasive articles.

### BACKGROUND

Abrasive articles are typically used to remove a small amount of material from a workpiece (or substrate). This is generally done to smooth the surface of the workpiece, but it can also be done to remove a layer of old material from the surface of the workpiece or even impart greater roughness to a surface of the workpiece in preparation for repair (e.g., application of a coating).

Abrasive articles come in many forms, including bonded abrasive articles (such as grinding wheels), coated abrasive articles, and nonwoven abrasive articles. Coated abrasive articles generally include a backing, abrasive particles, and a binder to anchor the abrasive particles to the backing. For example, in a typical coated abrasive product, the backing is coated with a layer of binder, commonly referred to as a “make” coat, and abrasive particles that are at least partially embedded in the make coat. The make coat is then sufficiently precured or set (such as by a series of drying or curing ovens) to adhere the abrasive particles to the backing. After precuring or setting the make coat, a second layer of binder, commonly referred to as a “size coat,” is applied over the surface of the make coat and abrasive particles, and, upon setting, it further supports the particles and enhances the anchorage of the particles to the backing. Optionally, a “supersize” coat, which may contain grinding aids, can be applied over the precured size coat. Once the size coat and optional supersize coat have been fully cured, the resulting coated abrasive article can be converted into a variety of convenient forms such as sheets, rolls, belts, and discs.

Grinding aids are typically added to abrasive articles during manufacture to enhance or improve performance of the abrasive articles. For example, the addition of grinding aids can significantly affect the chemical and physical processes of abrading metals to bring about improved performance, including decreasing the friction between the abrasive particles and the workpiece being abraded, preventing the abrasive particles from “capping” (i.e. preventing metal particles from becoming welded to the tops of the abrasive particles), decreasing the interface temperature between the abrasive particles and the workpiece, and/or decreasing the required grinding force. Grinding aids are particularly beneficial during the abrading of metals and exotic metal alloys, such as stainless steel or titanium. In some instances, the addition of a grinding aid can significantly improve the cut rate or abrading properties of the resulting coated abrasive over a coated abrasive that does not contain a grinding aid.

In some instances, the grinding aid is incompatible with the abrasive binders in the make and size coats. This incompatibility can lead to problems during processing and ultimately decrease performance of the abrasive article. For example, resole phenolic resin is a strong and durable structural adhesive commonly used as a binder in abrasive make and size coats, and KBF₄ is a preferred grinding aid for stainless steel. However, KBF₄ can interfere with the curing of the phenolic resin in basic conditions, thus creating problems during manufacture.

Various solutions to address the incompatibility of grinding aids in abrasive binders have been proposed. One such solution calls for an additional layer (e.g., supersize coating) comprising the grinding aid and a compatible resin binder (e.g., KBF 4 in an epoxy resin). In the case of multiple grinding aids, one or more additional coatings may be necessary, depending upon whether the multiple grinding aids are compatible in the same or different resin binders. The problem with this approach is that manufacture of the abrasive article requires one or more additional passes through the maker, resulting in manufacturing inefficiencies. Additionally, the cost of materials increases with each additional layer and binder incorporated therein.

Other solutions have focused on the nature of the grinding aid. For example, in U.S. Pat. No. 5,551,962, the grinding aid particles are coated with an inert, hydrophobic, hydrocarbon-containing substance to enhance compatibility with the binder. Grinding aid particles having the hydrophobic coating display reduced particle-particle attraction. Thus, the coated grinding aid particles have increased stability and compatibility when processed with aqueous resin systems. As a result, there is a reduced need to include antifoam agents or wetting agents in aqueous resin systems used to make a size or supersize coating that includes the coated grinding aid particles.

In U.S. Pat. No. 5,578,098, the grinding aids are formed into erodible agglomerates that provide a higher level of grinding aid without significantly reducing the strength of the binder.

### SUMMARY

The present disclosure provides a grinding aid particle where the active ingredient (i.e., grinding agent) is coated onto a soft core of support material. Such a configuration offers several potential benefits. For example, by immobilizing the grinding agent on the surface of the core, it is possible to reduce or prevent interference of the grinding agent with the processing and performance of abrasive materials. This allows for incorporation of the grinding aid particles into the binders of the make coat and/or the size coat, thus eliminating the need for supersize coats that require extra passes through the maker. It is particularly advantageous to be able to incorporate the grinding aid particles into the make coat along with the abrasive particles. Such a configuration reduces the chance that the grinding agent will be consumed before the abrasive particles wear out, as may be the case when the grinding agent is in the size coat or the supersize coat. Additionally, the grinding aid particles typically use less grinding agent than the grinding aid agglomerates made entirely of the grinding agent, providing a potentially less expensive alternative to incorporating grinding agents into the make and/or size coat resins.

In one embodiment, the present disclosure provides a grinding aid particle comprising a core particle having a surface, the core particle having a Mohs hardness less than 7, and a coating on at least a portion of the surface of the core particle, the coating comprising a binder and at least one grinding agent.

In another embodiment, the present disclosure provides a coated abrasive article comprising a backing having a first side and a second side, a make coat overlying the first side of the backing, a plurality of abrasive particles at least partially embedded in the make coat, an optional size coat overlying the make coat and abrasive particles, and a plurality of the grinding aid particles.

In a further embodiment, the present disclosure provides a method of making an abrasive article comprising providing a backing having a first side and a second side, applying a make coat precursor comprising a first curable binder onto the first side of the backing, applying abrasive particles to the make coat precursor, applying the grinding aid particles to the make coat precursor, and at least partially curing the make coat precursor containing the abrasive particles and grinding aid particles, wherein applying the abrasive particles and grinding aid particles to the make coat precursor can occur sequentially, in any order, or simultaneously.

As used herein:

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

In this application, terms such as “a,” “an,” and “the” are not intended to refer to only a singular entity, but include the general class of which a specific example may be used for illustration. The terms “a,” “an,” and “the” are used interchangeably with the phrases “at least one” and “one or more.” The phrases “at least one of” and “comprises at least one of” followed by a list refers to any one of the items in the list and any combination of two or more items in the list.

The term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, etc.).

Reference throughout this specification to “some embodiments” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

The term “overlie” means to extend over so as to at least partially cover another layer or element. Overlying layers can be in direct or indirect contact (e.g., separated by one or more additional layers).

The term “soft” means a material having a Mohs hardness value of less than 7.

The above summary of the present disclosure is not intended to describe each disclosed embodiment or every implementation of the present disclosure. The description that follows more particularly exemplifies illustrative embodiments.

### DETAILED DESCRIPTION

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

### Grinding Aid Particles

The grinding aid particles of the present disclosure refer to particulate material that is non-abrasive but has a noticeable effect on the chemical and physical process of abrading, thereby resulting in improved performance of a coated abrasive article. The grinding aid particle comprises a soft core particle having a Mohs hardness value less than 7. A coating extends over at least a portion of the surface of the core particle. The coating comprises a grinding agent, a binder, and optional additives. The grinding agent, as used herein, refers to the active component of the grinding aid particle that enhances the abrading process when added to an abrasive article.

The core particle provides a support for the grinding agent and can be made of a variety of soft materials, including a plant-based material (e.g., walnut shells, corn cobs, wood flour, and combinations thereof), nepheline syenite, a metal carbonate, silica, a silicate, a metal sulfate, gypsum, vermiculite, aluminum trihydrate, carbon black, a metal sulfite, sulfur, an organic sulfur compound, graphite, wax, polymeric material or combinations thereof.

In some embodiments, the core particles have a mean particle size of at least 0.3 micrometers, or at least 0.5 micrometers. In some embodiments, the core particles have a mean particle size up to 5,000 micrometers, or up to 2,000 micrometers. In some embodiments, the core particles have a mean particle size in the range of 0.3 to 5,000 micrometers, or 0.5 to 2,000 micrometers.

In some embodiments, the core particles have a D90 of at least 0.6 micrometers, at least micrometers, or at least 1.0 micrometers. In some embodiments, the core particles have a D90 of up to 10,000 micrometers, up to 7,000 micrometers, or up to 4,000 micrometers. In some embodiments, the core particles have a D90 in the range of 0.6 to 10,000 micrometers, 0.8 to 7,000 micrometers, or 1.0 to 4,000 micrometers. The D90 value, as used herein, is the particle size below which 90% of the particles fall based on volume distribution. D90 values can be determined by standard techniques, including light scattering methods and, in the case of larger particles, coulter counters.

The core particles may also be graded to a nominal screened grade using U.S. A. Standard Test Sieves conforming to ASTM E-11 “Standard Specification for Wire Cloth and Sieves for Testing Purposes”. ASTM E-11 prescribes the requirements for the design and construction of testing sieves using a medium of woven wire cloth mounted in a frame for the classification of materials according to a designated particle size. A typical designation may be represented as −18+20 meaning that the core particles pass through a test sieve meeting ASTM E-11 specifications for the number 18 sieve and are retained on a test sieve meeting ASTM E-11 specifications for the number 20 sieve. In some embodiments, the core particles have a particle size such that most of the particles pass through an 18 mesh test sieve and can be retained on a 20, 30, 35, 40, 45, or 50 mesh test sieve. In various embodiments, the ceramic particles can have a nominal screened grade of: −5+10, −10+14, −14+18, −18+20, −20+25, −25+30, −30+35, −35+40, −40+45, −45+50, −50+60, −60+70, −70+80, −80+100, −100+120, −120+140, −140+170, −170+200, −200+230, −230+270, −270+325, −325+400, −400+450, −450+500, or −500+635. Alternatively, a custom mesh size can be used such as −90+100.

The coating on the core particle comprises a binder. The binder can be any crosslinkable or non-crosslinkable resin or combination of resins. Exemplary resins include carboxymethylcellulose, methylcellulose, a phenolic resin, an aminoplast resin, a urethane resin, an acrylate resin, an epoxy resin, an ethylenically unsaturated resin, an acrylated isocyanurate resin, a urea-formaldehyde resin, an isocyanurate resin, an acrylated urethane resin, an acrylated epoxy resin, a bismaleimide resin, a fluorene modified epoxy resin or combinations thereof.

The coating further comprises a grinding agent. Examples of classes of grinding agents include a wide variety of different inorganic and organic materials, including organic halides, halogenated polymeric hydrocarbons, halide salts, and metallic sulfides. Organic halides, such as tetrachloronaphthalene and pentachloronaphthalene, will typically break down during abrading and release a halogen acid or a gaseous halide compound. Halogenated polymeric hydrocarbons include halogenated waxes, for example, chlorinated waxes, such as, polyvinylidene chloride, polyvinylidene fluoride, poly(vinyl chloride), and chlorinated poly(vinyl chloride). Halide salts include sodium chloride, potassium cryolite, cryolite, ammonium cryolite, potassium tetrafluoroborate, sodium tetrafluoroborate, silicon fluorides, potassium chloride, magnesium chloride, potassium tetrafluoroaluminate, potassium hexafluorozirconate, calcium fluoride. Metallic sulfides include cupric sulfide, molybdenum sulfide, and potassium sulfide.

Other exemplary grinding agents include sulfur, organic sulfur compounds, and graphite.

In some embodiments, the grinding agent comprises an organic halide compound, a halogenated polymeric hydrocarbon, a halide salt, a metallic sulfide or combinations thereof. More particularly, in some embodiments, the grinding agent comprises potassium tetrafluoroborate, cryolite, potassium tetrafluoroaluminate, potassium hexafluorozirconate, calcium fluoride, or combinations thereof.

The coating may comprise a single grinding agent. Alternatively, the coating may comprise two or more grinding agents. In some embodiments, the effects of two or more grinding agents on a single grinding aid particle may be additive (e.g., prevent abrasive particles from capping and reduce interface temperature between abrasive particles and workpiece). In other embodiments, the effects of two or more grinding agents on a single grinding aid particle may be synergistic (i.e. combined effect is greater than the sum of each grinding agent's separate effects).

The coating may optionally include one or more additives. The additives, unlike the grinding agent, do not directly affect the chemical or physical properties of abrading. Coating additives can be used, for example, to impart color to the coating, influence the curing of the coating binder, improve processability of the coating (e.g., adjusting viscosity), and enhance dispersion of the grinding agent within the coating. Exemplary coating additives include fibers, fillers, lubricants, wetting agents, surfactants, dispersants, pigments, dyes, coupling agents, plasticizers, suspending agents, rheology modifiers or combinations thereof.

The coating of the grinding aid particle typically comprises at least 5 wt %, at least 10 wt %, or at least 15 wt % grinding agent. The coating of the grinding aid particle typically comprises up to 80 wt %, up to 60 wt %, or up to 50 wt % grinding agent. In some embodiments, the coating of the grinding aid particle comprises 5 to 80 wt %, 10 to 60 wt %, or 15 to 50 wt % grinding agent.

In some embodiments, the coating completely encapsulates the core particle, forming a core/shell configuration. In other embodiments, the coating only partially covers the surface of the core particle, leaving a core particle with surface regions that are coated and other surface regions that are uncoated.

The grinding aid particle is not limited to a single coating and may in some embodiments include at least two coatings, where each coating comprises a different grinding agent or combination of grinding agents. The two or more coatings may cover different regions of the core particle surface. Alternatively, the coatings may at least partially overlap, such that at least a portion of one coating overlies at least a portion of one or more other coatings. In some preferred embodiments, a first coating encapsulates the core particle and a second coating encapsulates the first coating, forming a grinding aid particle with a core/shell/shell configuration.

The grinding aid particles of the present disclosure are nonabrasive and typically have a Mohs hardness of less than 7. Although the size of the grinding aid particles can vary with application, they are typically smaller than the abrasive particles in an abrasive article into which the grinding agents are incorporated. In some embodiments, the grinding aid particle has a mean particle size of at least 0.4, at least 0.7 micrometers, at least 0.9 micrometers, or at least 1.5 micrometers. In some embodiments, the grinding aid particle has a mean particle size of up to micrometers, up to 7,500 micrometers, up to 6,000 micrometers, or up to 3,000 micrometers. In some embodiments, the grinding aid particle has a mean particle size in the range of 0.4 to 15,000 micrometers, 0.7 to 7,500 micrometers, 0.9 to 6,000 micrometers, or 1.5 to 3,000 micrometers.

### Abrasive Articles

The grinding aid particles of the present disclosure can be incorporated into a variety of abrasive articles. Coated abrasive articles each generally comprise a backing having a first side and a second side, a make coat overlying the first side of the backing, and a plurality of abrasive particles at least partially embedded in the make coat. An optional size coat overlies the make coat and abrasive particles. One or more optional supersize coats overlie the size coat.

A plurality of grinding aid particles may be dispersed in the make coat, the optional size coat, the optional supersize coat(s), or any combination thereof. The term “dispersed”, as used in this context, means at least a portion of the grinding aid particles are imbedded in the coating. In some preferred embodiments, at least a portion of the plurality of grinding aid particles are dispersed in the make coat and, more preferably, the plurality of grinding aid particles are dispersed only in the make coat. In other preferred embodiments, the plurality of grinding aid particles are dispersed in both the make coat and the size coat of the coated abrasive article. Although less preferred, but certainly contemplated within this disclosure, are embodiments where the plurality of grinding aid particles are included in one or more supersize coats.

The plurality of grinding aid particles in a coated abrasive article may comprise one type of grinding aid particle, where each grinding aid particle is made of the same core material and the same coating composition. In alternative embodiments, the coated abrasive article includes two or more types of grinding aid particles. For example, the plurality of the grinding aid particles may comprise a first set of grinding aid particles comprising a first grinding agent and a second set of grinding aid particles comprising a second grinding agent, where the first and second grinding agents are different. The first and second set of grinding aid particles may be dispersed in the same coating or different coatings. In the latter case, for example, the first set of grinding aid particles may be dispersed in the make coat and the second set of grinding aid particles may be dispersed in the size coat.

The backing for the coated abrasive article can be made of any material that is compatible with the binder and that exhibits sufficient integrity for the expected abrading process. The backing can be elastic, inelastic or a combination of both. Elasticity helps promote contact between the abrasive particles and the underlying workpiece, and can be especially beneficial when the workpiece includes raised and/or recessed areas.

The backing is preferably flexible and may be either solid or porous. Flexible backing materials include: polymeric film (including primed films) such as polyolefin film (e.g., polypropylene including biaxially oriented polypropylene, polyester film, polyamide film, cellulose ester film); polyurethane rubber; metal foil; mesh; foam (e.g., natural sponge material or polyurethane foam); knitted, stitch bonded and/or woven fabrics (e.g., fabrics made from fibers or yarns comprising polyester, nylon, silk, cotton, and/or rayon); scrim; paper; coated paper; vulcanized paper; vulcanized fiber; nonwoven materials; felted fabric; combinations thereof; and, treated versions thereof. The backing may also be a laminate of two materials (e.g., paper/film, fabric/paper, film/fabric). In some embodiments, the backing comprises polymeric films, fabrics, paper, meshes, scrims, non-woven materials, vulcanized fiber, treated versions thereof, or combinations thereof.

Optionally, the backing may have at least one of a saturant, presize layer, or backsize layer. These materials can be used to seal the backing or to protect yarn or fibers present in the backing, or to modify the surface roughness, or to promote the adhesion between the backing and the make layer. If the backing is a cloth material, at least one of these materials is typically used. In some embodiments, the backing has a thickness of at least 0.02 millimeters, at least millimeters, at least 0.05 millimeters, at least 0.07 millimeters, or at least 0.1 millimeters. In some embodiments, the backing has a thickness of up to 5 millimeters, up to 4 millimeters, up to 2.5 millimeters, up to 1.5 millimeters, or up to 0.4 millimeters. In some embodiments, the backing has a thickness that ranges from 0.02 to 5 millimeters, 0.03 to 4 millimeters, 0.05 to 2.5 millimeters, 0.7 to 1.5 millimeters, or 0.1 to 0.4 millimeters.

The second side of the backing may be configured for gripping by a user and/or attachment to a tool or component of a tool (e.g., support pad or backup pad). The gripping or attachment layer may comprise a pressure sensitive adhesive, a loop fabric, a hook attachment or combination thereof. In some embodiments, the attachment layer may comprise an intermeshing system such as that described in U.S. Pat. No. 5,201,101. The gripping or attachment layer may be a separate layer that overlies the second side of the backing. Alternatively, the second side of the backing may be configured for attachments without the need for an additional layer (e.g., a nonwoven backing that can serve as the loop component of a hook and loop fastener).

The abrasive particles used to make the coated abrasive article are not particularly limiting and may be composed of a wide variety of hard minerals known in the art. Examples of suitable abrasive particles include, for example, fused aluminum oxide, heat treated aluminum oxide, white fused aluminum oxide, black silicon carbide, green silicon carbide, titanium diboride, boron carbide, silicon nitride, tungsten carbide, titanium carbide, diamond, cubic boron nitride, hexagonal boron nitride, garnet, fused alumina zirconia, alumina-based sol gel derived abrasive particles, silica, iron oxide, chromia, ceria, zirconia, titania, tin oxide, gamma alumina, and combinations thereof. The alumina abrasive particles may contain a metal oxide modifier. The diamond and cubic boron nitride abrasive particles may be monocrystalline or polycrystalline.

The abrasive particles may be provided in a variety of sizes, shapes and profiles, including, for example, random or crushed shapes, regular (e.g. symmetric) profiles such as square, star-shaped or hexagonal profiles, and irregular (e.g. asymmetric) profiles.

The abrasive article may include a mixture of different types of abrasive particles. For example, the abrasive article may include mixtures of platey and non-platey particles, crushed and shaped particles (which may be discrete abrasive particles that do not contain a binder or agglomerate abrasive particles that contain a binder), conventional non-shaped and non-platey abrasive particles (e.g. filler material) and abrasive particles of different sizes.

The abrasive particles may be surface-treated with a coupling agent (e.g., an organosilane coupling agent) or other physical treatment (e.g., iron oxide or titanium oxide) to enhance adhesion of the crushed abrasive particles to the binder.

The abrasive particles may have a substantially monodisperse size (e.g., abrasive particles formed through replication) or the abrasive particles may have a range or distribution of particle sizes. In some embodiments, the number average particle size of the abrasive particles may range from 0.001 to 300 micrometers, 0.01 and 250 micrometers, or 0.02 and 100 micrometers, where the particle size of the abrasive particle is measured by the longest dimension of the abrasive particle.

The make coat and optional size coat may be used to secure the abrasive particles to the backing. Each coat typically includes one or more binders having rheological and wetting properties suitable for selective deposition onto a backing.

Typically, binders are formed by curing (e.g., by thermal means, or by using electromagnetic or particulate radiation) a binder precursor. Useful binder precursors are known in the abrasive art and include, for example, free-radically polymerizable monomer and/or oligomer, epoxy resins, acrylic resins, epoxy-acrylate oligomers, urethane-acrylate oligomers, urethane resins, phenolic resins, urea-formaldehyde resins, melamine-formaldehyde resins, aminoplast resins, cyanate resins, or combinations thereof. Binder precursors include thermally curable resins and radiation curable resins, which may be cured, for example, thermally and/or by exposure to radiation.

Optionally, one or more additional supersize coats are applied to the abrasive article. If a supersize coat is applied, it is preferably in registration with the make coat and size coat, as viewed in directions normal to the plane of the major surface of the backing. The supersize coat may include, for example, grinding aids. In some embodiments, the supersize coat provides enhanced lubricity during an abrading operation.

Any of the make coat, size coat, and supersize coat described above optionally include one or more curatives. Curatives include those that are photosensitive or thermally sensitive, and preferably comprise at least one free-radical polymerization initiator and at least one cationic polymerization catalyst, which may be the same or different.

In some embodiments including photosensitive curatives, the photoinitiator is capable of at least partially polymerizing (e.g., curing) free-radically polymerizable components of the binder precursor. Useful photoinitiators include those known as useful for photocuring free-radically polyfunctional acrylates. Exemplary photoinitiators include bis(2,4,6-trimethylbenzoyl)-phenylphosphineoxide, commercially available under the trade designation “IRGACURE 819” from BASF Corporation, Florham Park, N.J.; benzoin and its derivatives such as alpha-methylbenzoin; alpha-phenylbenzoin; alpha-allylbenzoin; alpha-benzylbenzoin; benzoin ethers such as benzil dimethyl ketal (e.g., as commercially available under the trade designation “IRGACURE 651” from BASF Corporation), benzoin methyl ether, benzoin ethyl ether, benzoin n-butyl ether; acetophenone and its derivatives such as 2-hydroxy-2-methyl-1-phenyl-1-propanone (e.g., as commercially available under the trade designation “DAROCUR 1173” from BASF Corporation. Photocatalysts as defined herein are materials that form active species that, if exposed to actinic radiation, are capable of at least partially polymerizing the binder precursor, e.g., an onium salt and/or cationic organometallic salt. Preferably, onium salt photocatalysts comprise iodonium complex salts and/or sulfonium complex salts. Aromatic onium salts, useful in practice of the present embodiments, are typically photosensitive only in the ultraviolet region of the spectrum. However, they can be sensitized to the near ultraviolet and the visible range of the spectrum by sensitizers for known photolyzable organic halogen compounds. Useful commercially available photocatalysts include an aromatic sulfonium complex salt having the trade designation “UVI-6976”, available from Dow Chemical Co. Photoinitiators and photocatalysts useful in the present invention can be present in an amount in the range of 0.01 to 10 weight percent, desirably 0.01 to 5, most desirably 0.1 to 2 weight percent, based on the total amount of photocurable (i.e., crosslinkable by electromagnetic radiation) components of the binder precursor, although amounts outside of these ranges may also be useful.

The make coat, size coat and supersize coat(s) may optionally contain any of a number of optional additives. Such additives may be homogeneous or heterogeneous with one or more components in the composition. Heterogenous additives may be discrete (e.g., particulate) or continuous in nature.

Aforementioned additives can include, for example, fillers, stabilizers, plasticizers, tackifiers, flow control agents, cure rate retarders, adhesion promoters (for example, silanes such as (3-glycidoxypropyl)trimethoxysilane (GPTMS), and titanates), adjuvants, impact modifiers, expandable microspheres, thermally conductive particles, electrically conductive particles, and the like, such as silica, glass, clay, talc, pigments, colorants, glass beads or bubbles, and antioxidants, so as to reduce the weight and/or cost of the structural layer composition, adjust viscosity, and/or provide additional reinforcement or modify the thermal conductivity of compositions and articles used in the provided methods so that a more rapid or uniform cure may be achieved.

### Method of Making Coated Abrasive Articles

The coated abrasive articles can be made by any conventional techniques. For example, the abrasive article can be made by providing a backing having a first side and a second side, applying a make coat precursor comprising a first curable binder onto the first side of the backing, applying abrasive particles to the make coat precursor, applying the grinding aid particles to the make coat precursor, and at least partially curing the make coat precursor containing the abrasive particles and grinding aid particles. The abrasive particles and grinding aid particles can be applied to the make coat precursor sequentially, in any order, or simultaneously using a variety of techniques, including drop coating or electrostatic coating. In some instances, the make coat precursor is partially cured and a size coat precursor comprising a second curable binder is applied to the partially cured make coat precursor followed by curing the partially cured make coat precursor and size coat precursor.

In an alternative embodiment, the abrasive article can be made by (1) mixing together abrasive particles, grinding aid particles, and a make coat precursor comprising a first curable binder, (2) applying the mixture to one side of a backing, and (3) at least partially curing the make coating precursor. In some instances, the make coating precursor is partially cured, and a size coat precursor comprising a second curable binder is applied to the partially cured make coat precursor followed by curing the partially cured make coat precursor and size coat precursor.

The above methods may further comprise providing grinding aid particles in the size coat precursor or on the surface of the size coat precursor prior to curing the partially cured make coat precursor and size coat precursor. The grinding aid particles in the size coat may be of the same type or different type than the grinding aid particles in the make coat. Similarly, the first curable binder and second curable binder may be the same or different.

The above methods may also include the addition of one or more supersize coats. Typically, supersize coat precursors are applied to a partially cured size coat precursor and the partially cured size coat and supersize coat(s) are cured. Grinding aid particles can be incorporated into the supersize coat precursor or deposited on the surface of the supersize coat precursor prior to curing. The grinding aid particle may be of the same type or different from those incorporated into the make coat and/or size coat.

In some embodiments, the grinding aid particle may be incorporated into the size coat but not the make layer. For example, an abrasive article can be made by providing a backing having a first side and a second side, applying a make coat precursor comprising a first curable binder onto the first side of the backing, applying abrasive particles to the make coat precursor, at least partially curing the make coat precursor containing the abrasive particles, applying a size coat precursor containing a second curable binder and grinding aid particles to the partially cured make coat precursor, and curing the partially cured make coat precursor and size coat precursor containing the grinding aid particles. The method may further include the addition of one or more supersize coats. Typically, supersize coat precursors are applied to the partially cured size coat precursor containing grinding aid particles, and the partially cured size coat precursor and supersize coat precursors are cured. Grinding aid particles can be incorporated into the supersize coat precursor or deposited on the surface of the supersize coat precursor prior to curing. The grinding aid particle may be of the same type or different from those incorporated into the size coat.

Method of Abrading a Workpiece

The coated abrasive articles of the present application can be used, for example, to abrade a workpiece. The method includes frictionally contacting the abrasive side of the article with a surface of the workpiece, and moving at least one of the abrasive article and the surface of the workpiece relative to the other to abrade at least a portion of the surface of the workpiece. Methods for abrading with abrasive articles of the present disclosure include, for example, snagging (i.e., high-pressure high stock removal) to polishing (e.g., polishing medical implants with coated abrasive belts), wherein the latter is typically done with finer grades (e.g., ANSI 220 and finer) of abrasive particles.

Abrading may be carried out dry or wet. For wet abrading, the liquid may be supplied in the form of a light mist to complete flood. Examples of commonly used liquids include water, water-soluble oil, organic lubricant, and emulsions. The liquid may serve to reduce the heat associated with abrading and/or act as a lubricant. The liquid may contain minor amounts of additives such as bactericide, antifoaming agents, and the like.

Examples of workpieces include aluminum metal, carbon steels, mild steels (e.g., 1018 mild steel and 1045 mild steel), tool steels, stainless steel, hardened steel, titanium, glass, ceramics, wood, wood-like materials (e.g., plywood and particle board), paint, painted surfaces, organic coated surfaces and the like. The applied force during abrading typically ranges from about 1 to about 100 kilograms (kg), although other pressures can also be used.

Although the grinding aid particles of the present disclosure have been described in the context of coated abrasive articles, it should be understood that the grinding aid particles could be utilized in other abrasive articles, as well.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

The following abbreviations are used in this section: L-liters, g=grams, kg=kilograms, m=meters, g/m²=grams per square meter, kg=kilograms, cm=centimeters, mm=millimeters, μm=micrometers, wt %=percent by weight, min=minutes, h=hours, cPs=centiPoise, rpm=revolutions per minute, psi=pounds per square inch, kPa=kiloPascal, cfm=cubic feet per minute, m³/min=cubic meters per minute.

All materials are commercially available, for example from MilliporeSigma, St. Louis, MO, USA, or known to those skilled in the art, unless otherwise stated or apparent. Abbreviations for materials used in this section, as well as descriptions of the materials, are provided in Table 1.

### Materials

TABLE 1

| Material | Details |
|---|---|
| KBF₄ spec 101 | potassium tetrafluoroborate, powder (D₅₀ = 50 μm, D₉₀ = 100 μm), |
| | available from ShoreChem, Nantong Jinxing, China |
| KBF₄ spec 102 | potassium tetrafluoroborate, powder (D₅₀ = 6 μm, D₉₀ = 17 μm), |
| | available from ShoreChem |
| Cryolite | Sodium hexafluoroaluminate, powder, available from Solvay |
| | Fluorides, LLC, Houston, TX |
| K₂ZrF₆ | potassium hexafluorozirconate, powder, available from GFS |
| | Chemicals, Powell, OH |
| CaF₂ | calcium fluoride, precipitated, 97%, available from Alfa Aesar, |
| | Tewksbury, MA |
| carboxymethylcellulose | sodium salt of carboxymethylcellulose, low viscosity, available from |
| | MilliporeSigma, St. Louis, MO |
| PVP | polyvinylpyrrolidone, average molecular weight 58,000, available |
| | from Alfa Aesar |
| methylcellulose | Methyl cellulose, viscosity 15 cPs, available from Alfa Aesar |
| BYK-W 9012 | Solvent-free wetting and dispersing additive, available from BYK- |
| | Chemie GmbH, Wesel, Germany |
| Foamaster | Anti-foaming agent available under the trade designation |
| | “FOAMASTER M02184” from BASF, Ludwigshafen, Germany |
| Phenolic resin | Available under the trade designation “GP 8339 R-23155B” from |
| | Georgia Pacific Chemicals, Atlanta, GA |
| YF coated backing | Untreated polyester cloth having a weight of 300-400 g/m², available |
| | under the trade designation “POWERSTRAIT” from Milliken & |
| | Company, Spartanburg, S.C. |
| nepheline syenite | Crushed nepheline syenite with average diameter of about 1 mm |
| | available from 3M, St. Paul, MN |
| walnut shells | Crushed walnut shells in which 95 wt % passes through a #18 U.S. |
| | standard sieve and 5 wt % passes through a #40 U.S. standard sieve, |
| | available from Composition Materials, Inc., Milford, CT |
| Com cobs | Crushed corn cobs in which 95 wt % passes through a #14 U.S. |
| | standard sieve and 5 wt % passes through a #20 U.S. standard sieve, |
| | available from Composition Materials |
| AP2 | Shaped abrasive particles were prepared according to the disclosure |
| | of U.S. Pat. No. 8,142,531 (Adefris et al). The shaped abrasive |
| | particles were prepared by molding alumina sol gel in equilateral |
| | triangle-shaped polypropylene mold cavities of side length 2.794 mm |
| | and a mold depth of 0.711 mm. After drying and firing, the resulting |
| | shaped abrasive particles were about 1.4 mm (side length) × 0.35 mm |
| | (thickness), with a draft angle approximately 98 degrees. |
| AP3 | Shaped abrasive particles were prepared according to the disclosure |
| | of U.S. Pat. No. 8,142,531 (Adefris et al). The shaped abrasive |
| | particles were prepared by molding alumina sol gel in equilateral |
| | triangle-shaped polypropylene mold cavities of side length 2.794 mm |
| | and a mold depth of 0.931 mm. After drying and firing, the resulting |
| | shaped abrasive particles were about 1.4 mm (side length) × 0.467 |
| | mm (thickness), with a draft angle approximately 98 degrees. |
| FIL2 | Hydrophilic amorphous fumed silica available under the trade |
| | designation “CAB-O-SIL M-5” from Cabot Corporation, Alpharetta, |
| | GA |
| FIL4 | Potassium tetrafluoroborate available from AWSM Industries, |
| | Paramus, NJ |
| ADD2 | Sodium dioctyl sulfosuccinate surfactant available under trade |
| | designation “AEROSOL OT-NV” from Cytec-Solvay Group, |
| | Stamford, CT |
| ADD3 | Antifoam under trade designation “ANTIFOAM EMULSION 1430” |
| | from Dow Chemical, Midland, MI |
| EP | Epoxy Resin commercially available under trade designation |
| | “EXPIREZ 3520 W60” from Hexion, Columbus, OH |
| RS | Latex Dispersion available under trade designation “SURE TAC |
| | 1585” from Dyna-Tech Adhesives, Grafton, WV |
| RIO2 | Red iron oxide pigment obtained under the trade designation |
| | “KROMA RO-8097” from Elementis, East Saint Louis, IL |
| EMI | 2-Ethyl-4-methyl imidazole, obtained as EMI-2,4 from Air Products, |
| | Allentown, Pennsylvania. |

### Grinding Test

A grinding test was conducted on 10.16 cm by 91.44 cm belts converted from the coated abrasives of Examples 1 through 5 and Comparative Example A. The workpiece was a 304 stainless steel bar on which the surface to be abraded measured 1.9 cm by 1.9 cm. A 20.3 cm diameter 70 durometer rubber, 1:1 land to groove ratio, serrated contact wheel was used. The belt was run at 2750 rpm. The workpiece was applied to the center part of the belt at a normal force of 4.4-6.8 kg. The test consisted of measuring the weight loss of the workpiece after 16 seconds of grinding. The workpiece would then be cooled and tested again. The test was concluded after 40 cycles. The total cut results, defined as total cut in g after 40 cycles, are reported in Table 2.

### Preparatory Example 1 (PE-1)

A milled dispersion of KBF 4 was prepared by mixing 400 g water, 600 g KBF 4 spec 101, 6 g ADD2, and 2 g Foamaster. The components were charged into a double-walled jacketed stainless-steel mixing vessel. Milling was performed using a Dispermat CV-3 Plus (VMA-Getzmann GMBH, Germany) with a basket mill attachment fitted with a 0.25 mm separation screen, 8-peg impeller, marine prop agitator and loaded with 155 g of 0.5 mm yttrium-stabilized zirconia beads (Torayceram Beads, Toray Industries, Inc). The milling was run for 2 h at 2500 rpm. The KBF₄ concentration was estimated to be ˜60 wt %. The resulting sample had a particle size distribution with mean particle size of 4 μm and D90 of 5 μm (i.e. 90% of the particles were below 5 μm based on volume distribution).

To a large stainless-steel beaker of water (2.3 kg) was added carboxymethylcellulose (135 g) and this was agitated with a Cowles blade for 30 min. The combination of two milling runs (2.0 kg) was added to this solution and this was stirred an additional 10 min. This was the final formulation of the coating solution used in EX-1, EX-5 and EX-6.

### Preparatory Example 2 (PE-2)

A milled dispersion of cryolite was prepared by mixing 400 g water, cryolite (500 g), and BYK-W 9012 (5.0 g). The components were charged into a double-walled jacketed stainless-steel mixing vessel. Milling was performed using a Dispermat CV-3 Plus (VMA-Getzmann GMBH, Germany) with a basket mill attachment fitted with a 0.25 mm separation screen, 8-peg impeller, marine prop agitator and loaded with 155 g of 0.5 mm yttrium-stabilized zirconia beads (Torayceram Beads, Toray Industries, Inc). The milling was run for 2 h at 2500 rpm. The cryolite concentration was estimated to be −56 wt %. The resulting sample had a particle size distribution with median particle size of 4.6 μm and D90 of 5.1 μm (i.e. 90% of the particles were below 5.1 μm based on volume distribution).

To a large stainless-steel beaker of water (820 g) was added PVP (23 g) and this was agitated with a Cowles blade for 30 min. The milled dispersion of cryolite (900 g) was added to this solution and this was stirred an additional 10 min. This was the final formulation of the coating solution used in EX-2.

### Preparatory Example 3 (PE-3)

A milled dispersion of K₂ZrF₆ was prepared by mixing 400 g water, K₂ZrF₆ (600 g), and BYK-W 9012 (6.0 g). The components were charged into a double-walled jacketed stainless-steel mixing vessel, Milling was performed using a Dispermat CV-3 Plus (VMA-Getzmann GMBH, Germany) with a basket mill attachment fitted with a 0.25 mm separation screen, 8-peg impeller, marine prop agitator and loaded with 155 g of 0.5 mm yttrium-stabilized zirconia beads (Torayceram Beads, Toray Industries, Inc). The milling was run for 1 hour at 2500 rpm. The K₂ZrF₆ concentration was estimated to be ˜60 wt %. The resulting sample had a particle size distribution with median particle size of 3.1 μm and D90 of 5.1 μm (i.e. 90% of the particles were below 5.1 μm based on volume distribution). This was repeated twice so that enough material was available for the particle coating (EX-3).

To a large stainless-steel beaker of water (820 g) was added PVP (23 g) and this was agitated with a Cowles blade for 30 min. The milled dispersion of cryolite (1855 g) was added to this solution and this was stirred an additional 10 min. This is the final formulation of the coating solution used in EX-3.

### Preparatory Example 4 (PE-4)

A milled dispersion of CaF₂ was prepared by mixing 550 g water, CaF₂ (450 g), and BYK-W 9012 (5.0 g). The components were charged into a double-walled jacketed stainless-steel mixing vessel, Milling was performed using a Dispermat CV-3 Plus (VMA-Getzmann GMBH, Germany) with a basket mill attachment fitted with a 0.27 mm separation screen loaded with 155 g of 0.5 mm yttrium-stabilized zirconia beads (Torayceram Beads, Toray Industries, Inc). The milling was run for 2 h at 1500 rpm. The CaF₂ concentration was estimated to be −45 wt %. The resulting sample had a particle size distribution with median particle size of 3.7 urn and D90 of 5.6 μm (i.e. 90% of the particles were below 5.6 μm based on volume distribution).

To a large stainless-steel beaker of water (570 g) was added PVP (40 g) and this was agitated with a Cowles blade for 30 min. The milled dispersion of CaF₂ (950 g) was added to this solution and this was stirred an additional 10 min. This is the final formulation of the coating solution used in EX-4.

### Preparatory Example 5 (PE-5)

Water (500 g) was stirred with a Cowles blade (Dispermat CV-3 Plus, VMA-Getzmann GMBH, Germany) while the KBF 4 spec 102 (500 g) was added in 100 g portions. After the final addition of KBF₄ the speed was increased to 4000 RPM for 5-10 min. The speed was decreased to 1000 RPM and the ADD2 (1.00 g) and ADD3 (5 drops) were added. This was stirred an additional 15 min and then collected.

To a large stainless-steel beaker of water (800 g) was added carboxymethylcellulose (56 g) and this was agitated with a Cowles blade for 30 min. The dispersion of KBF 4 (950 g) was added to this solution and this was stirred an additional 10 min. This is the final formulation of the coating solution used in EX-7.

### Preparatory Example 6 (PE-6)

A 3 L plastic container was charged with 438 parts of EP, 173 parts of water, 8.7 parts of FIL2, 55.1 parts of R102, 13.8 parts of EMI, 18.1 parts of ADD2, 1.9 parts of ADD3 and 319.4 parts of RS and then mixed for 10 min with an overhead mechanical stirrer. Next, 1972 parts of FIL4 was added over a 15 min period. The resultant mixture was stirred for 15 min with an overhead stirrer.

### Example 1 (EX-1)

The KBF₄ dispersion of PE-1 was placed on a balance and agitated with an overhead stirrer. The particle coating was performed in a fluid bed system available under the trade designation VFC-LAB 1 FLO-COATER from Freund-Vector Corporation (Marion, IA). A tube with a stainless steel “straw” was attached to the side of the stainless-steel beaker to pump the slurry into the fluidized bed nozzle. The peristaltic pump was calibrated. The “bowl” of the fluidized bed was loaded with 2.0 kg of walnut shells for the granulator configuration (top spray) with a 60 mesh Conidur plate. The column was allowed a short heat up period of about 10 min before spraying of the dispersion was initiated. The dispersion was sprayed at a rate of 22 g/min and a total weight of 3.5 kg of dispersion was sprayed into the fluidized bed column to give a nominal coating level of 34 wt %, based on the charge of core particles and the weight percent of solids in the coating solution. The following settings were used: 20 psi (138 kPa) atomization gas, bed temperature 40-44° C., inlet air temperature of 74-81° C., and an inlet air flow of 30 cfm (0.85 m³/min). The run was completed in about 160 min.

### Example 2 (EX-2)

The cryolite dispersion of PE-2 was placed on a balance and agitated with an overhead stirrer. The particle coating was performed in a fluid bed system available under the trade designation VFC-LAB 1 FLO-COATER from Freund-Vector Corporation (Marion, IA). A tube with a stainless steel “straw” was attached to the side of the stainless-steel beaker to pump the slurry into the fluidized bed nozzle. The peristaltic pump was calibrated. The “bowl” of the fluidized bed was loaded with 1.8 kg of walnut shells for the granulator configuration (top spray) with a 60 mesh Conidur plate. The column was allowed a short heat up period of about 10 min before spraying of the dispersion was initiated. The dispersion was sprayed at a rate of 28.5 g/min and a total weight of 2.5 kg of dispersion was sprayed into the fluidized bed column to give a nominal coating level of 30 wt % solids, based on the charge of core particles and the weight percent of solids in the coating solution. The following settings were used: 15 psi (103 kPa) atomization gas, bed temperature 39-43° C., inlet air temperature of 85-90° C., and an inlet air flow of 30 cfm (0.85 m³/min). The run was completed in about 90 min.

### Example 3 (EX-3)

The K₂ZrF₆ dispersion of PE-3 was placed on a balance and agitated with an overhead stirrer. The particle coating was performed in a fluid bed system available under the trade designation VFC-LAB 1 FLO-COATER from Freund-Vector Corporation (Marion, IA). A tube with a stainless steel “straw” was attached to the side of the stainless-steel beaker to pump the slurry into the fluidized bed nozzle. The peristaltic pump was calibrated. The “bowl” of the fluidized bed was loaded with 2.0 kg of corn cobs for the granulator configuration (top spray) with a 60 mesh Conidur plate. The column was allowed a short heat up period of about 10 min before spraying of the dispersion was initiated. The dispersion was sprayed at a rate of 22 g/min and a total weight of 2.0 kg of dispersion was sprayed into the fluidized bed column to give a nominal coating level of 23 wt % solids, based on the charge of core particles and the weight percent of solids in the coating solution. The following settings were used: 25 psi atomization gas, bed temperature 39-44° C., inlet air temperature of 65-80° C., and an inlet air flow of 35 cfm. The run was completed in about 100 min.

### Example 4 (EX-4)

The CaF₂ dispersion of PE-4 was placed on a balance and agitated with an overhead stirrer. The particle coating was performed in a fluid bed system available under the trade designation VFC-LAB 1 FLO-COATER from Freund-Vector Corporation (Marion, IA). A tube with a stainless-steel “straw” was attached to the side of the stainless-steel beaker to pump the slurry into the fluidized bed nozzle. The peristaltic pump was calibrated. The “bowl” of the fluidized bed was loaded with 2.0 kg of corn cobs for the granulator configuration (top spray) with a 60 mesh Conidur plate. The column was allowed a short heat up period of about 10 min before spraying of the dispersion was initiated. The dispersion was sprayed at a rate of 24.5 g/min and a total weight of 1.5 kg of dispersion was sprayed into the fluidized bed column to give a nominal coating level of 18 wt % solids, based on the charge of core particles and the weight percent of solids in the coating solution. The following settings were used: 15 psi atomization gas, bed temperature 44° C., inlet air temperature of 80° C., and an inlet air flow of 35 cfm. The run was completed in about 65 min.

### Example 5 (EX-5)

The KBF₄ dispersion of PE-1 was placed on a balance and agitated with an overhead stirrer. The particle coating was performed in a fluid bed system available under the trade designation VFC-LAB 1 FLO-COATER from Freund-Vector Corporation (Marion, IA). A tube with a stainless-steel “straw” was attached to the side of the stainless-steel beaker to pump the slurry into the fluidized bed nozzle. The peristaltic pump was calibrated. The “bowl” of the fluidized bed was loaded with 2.0 kg of corn cobs for the granulator configuration (top spray) with a 60 mesh Conidur plate. The column was allowed a short heat up period of about 10 min before spraying of the dispersion was initiated. The dispersion was sprayed at a rate of 30 g/min and a total weight of 6.5 kg of dispersion was sprayed into the fluidized bed column to give a nominal coating level of 50 wt % solids, based on the charge of core particles and the weight percent of solids in the coating solution. The following settings were used: 25 psi atomization gas, bed temperature 41-51° C., inlet air temperature of 70-85° C., and an inlet air flow of 32-60 cfm. The run was completed in about 240 min.

### Example 6 (EX-6)

The KBF₄ dispersion of PE-1 was placed on a balance and agitated with an overhead stirrer. The particle coating was performed in a fluid bed system available under the trade designation VFC-LAB 1 FLO-COATER from Freund-Vector Corporation (Marion, IA). A tube with a stainless-steel “straw” was attached to the side of the stainless-steel beaker to pump the slurry into the fluidized bed nozzle. The peristaltic pump was calibrated. The “bowl” of the fluidized bed was loaded with 4.25 kg of nepheline syenite for the granulator configuration (top spray) with a 60 mesh Conidur plate. The column was allowed a short heat up period of about 10 min before spraying of the dispersion was initiated. The dispersion was sprayed at a rate of 31 g/min and a total weight of 1.2 kg of dispersion was sprayed into the fluidized bed column to give a nominal coating level of 8 wt % solids, based on the charge of core particles and the weight percent of solids in the coating solution. The following settings were used: 25 psi atomization gas, bed temperature of about 45° C., inlet air temperature of about 70° C., and an inlet air flow of 60 cfm. The run was completed in about 40 min.

### Example 7 (EX-7)

The KBF₄ dispersion of PE-5 was placed on a balance and agitated with an overhead stirrer. The particle coating was performed in a fluid bed system available under the trade designation VFC-LAB 1 FLO-COATER from Freund-Vector Corporation (Marion, IA). A tube with a stainless-steel “straw” was attached to the side of the stainless-steel beaker to pump the slurry into the fluidized bed nozzle. The peristaltic pump was calibrated. The “bowl” of the fluidized bed was loaded with 4.17 kg of nepheline syenite for the granulator configuration (top spray) with a 60 mesh Conidur plate. The column was allowed a short heat up period of about 10 min before spraying of the dispersion was initiated. The dispersion was sprayed at a rate of 30 g/min and a total weight of 1.2 kg of dispersion was sprayed into the fluidized bed column to give a nominal coating level of 8 wt % solids, based on the charge of core particles and the weight percent of solids in the coating solution. The following settings were used: 25 psi atomization gas, bed temperature of about 45° C., inlet air temperature of about 65° C., and an inlet air flow of 60 cfm. The run was completed in about 60 min.

### Example 8 (EX-8)

Untreated polyester cloth having a basis weight of 300-400 g/m², obtained under the trade designation “POWERSTRAIT” from Milliken & Company, Spartanburg, South Carolina, was pre-sized at the basis weight of 113 g/m² with a composition consisting of 75 parts epoxy resin (bisphenol A diglycidyl ether, obtained under trade designation “EPON 828” from Resolution Performance Products, Houston, Texas), 10 parts of trimethylolpropane triacrylate (obtained under trade designation “SR351” from Cytec Industrial Inc., Woodland Park, New Jersey), 8 parts of dicyandiamide curing agent (obtained under trade designation “DICYANEX 1400B” from Air Products and Chemicals, Allentown, Pennsylvania), 5 parts of novolac resin (obtained under trade designation “RUTAPHEN 8656” from Momentive Specialty Chemicals Inc., Columbus, Ohio), 1 part of 2,2-dimethoxy-2-phenylacetophenone (obtained under trade designation “IRGACURE 651” photoinitiator from BASF Corporation, Florham Park, New Jersey), and 0.75 part of 2-propylimidazole (obtained under trade designation “ACTIRON NXJ-60 LIQUID” from Synthron, Morganton, North Carolina).

The cloth backing was coated with 172 g/m² of a phenolic make resin consisting of 52 parts of resole phenolic resin (obtained under trade designation “GP 8339 R-23155B” from Georgia Pacific Chemicals, Atlanta, Georgia), 45 parts of calcium metasilicate (obtained under trade designation “WOLLASTOCOAT” from NYCO Company, Willsboro, NY), and 2.5 parts of water.

Abrasive particles AP2 were applied to the make resin-coated backing via an electrostatic coating device as is known in the art. The coating weight of AP2 was 510.6 g/sqm. Immediately after abrasive particles AP2 were coated onto the backing, coated particles of EX-1 were drop coated onto the backing with a coating weight of 179.0 g/sqm.

The abrasive coated backing was placed in an oven at 90° C. for 1.5 h to partially cure the make resin. A size resin consisting of 45.76 parts of resole phenolic resin (obtained under trade designation “GP 8339 R-23155B” from Georgia Pacific Chemicals), 4.24 parts of water, 24.13 parts of cryolite (Solvay Fluorides, LLC, Houston, Texas), 24.13 parts calcium metasilicate (obtained under trade designation “WOLLASTOCOAT” from NYCO Company, Willsboro, New York) and 1.75 parts red iron oxide was applied to each strip of backing material at a basis weight of 675 g/m², and the coated strip was placed in an oven at 90° C. for 1 hour, followed by 8 h at 102° C. After cure, the strip of coated abrasive was converted into a belt as is known in the art.

### Example 9 (EX-9)

Untreated polyester cloth having a basis weight of 300-400 g/m², obtained under the trade designation “POWERSTRAIT” from Milliken & Company, Spartanburg, South Carolina, was pre-sized at the basis weight of 113 g/m² with a composition consisting of 75 parts epoxy resin (bisphenol A diglycidyl ether, obtained under trade designation “EPON 828” from Resolution Performance Products, Houston, Texas), 10 parts of trimethylolpropane triacrylate (obtained under trade designation “SR351” from Cytec Industrial Inc., Woodland Park, New Jersey), 8 parts of dicyandiamide curing agent (obtained under trade designation “DICYANEX 1400B” from Air Products and Chemicals, Allentown, Pennsylvania), 5 parts of novolac resin (obtained under trade designation “RUTAPHEN 8656” from Momentive Specialty Chemicals Inc., Columbus, Ohio), 1 part of 2,2-dimethoxy-2-phenylacetophenone (obtained under trade designation “IRGACURE 651” photoinitiator from BASF Corporation, Florham Park, New Jersey), and 0.75 part of 2-propylimidazole (obtained under trade designation “ACTIRON NXJ-60 LIQUID” from Synthron, Morganton, North Carolina).

The cloth backing was coated with 172 g/m² of a phenolic make resin consisting of 52 parts of resole phenolic resin (obtained under trade designation “GP 8339 R-23155B” from Georgia Pacific Chemicals, Atlanta, Georgia), 45 parts of calcium metasilicate (obtained under trade designation “WOLLASTOCOAT” from NYCO Company, Willsboro, NY), and 2.5 parts of water.

Abrasive particles AP2 were applied to the make resin-coated backing via an electrostatic coating device as is known in the art. The coating weight of AP2 was 521.5 g/sqm. Immediately after abrasive particles AP2 were coated onto the backing, coated particles of EX-1 were drop coated onto the backing with a coating weight of 181.2 g/sqm.

The abrasive coated backing was placed in an oven at 90° C. for 1.5 h to partially cure the make resin. A size resin consisting of 45.76 parts of resole phenolic resin (obtained under trade designation “GP 8339 R-23155B” from Georgia Pacific Chemicals), 4.24 parts of water, 24.13 parts of cryolite (Solvay Fluorides, LLC, Houston, Texas), 24.13 parts calcium metasilicate (obtained under trade designation “WOLLASTOCOAT” from NYCO Company, Willsboro, New York) and 1.75 parts red iron oxide was applied to each strip of backing material at a basis weight of 675 g/m². Before curing the size coating, coated particles of EX-1 were drop coated onto the size-coated material with a coating weight of 177 g/sqm. The coated strip was then placed in an oven at 90° C. for 1 hour, followed by 8 h at 102° C. After cure, the strip of coated abrasive was converted into a belt as is known in the art.

### Example 10 (EX-10)

Untreated polyester cloth having a basis weight of 300-400 g/m², obtained under the trade designation “POWERSTRAIT” from Milliken & Company, Spartanburg, South Carolina, was pre-sized at the basis weight of 113 g/m² with a composition consisting of 75 parts epoxy resin (bisphenol A diglycidyl ether, obtained under trade designation “EPON 828” from Resolution Performance Products, Houston, Texas), 10 parts of trimethylolpropane triacrylate (obtained under trade designation “SR351” from Cytec Industrial Inc., Woodland Park, New Jersey), 8 parts of dicyandiamide curing agent (obtained under trade designation “DICYANEX 1400B” from Air Products and Chemicals, Allentown, Pennsylvania), 5 parts of novolac resin (obtained under trade designation “RUTAPHEN 8656” from Momentive Specialty Chemicals Inc., Columbus, Ohio), 1 part of 2,2-dimethoxy-2-phenylacetophenone (obtained under trade designation “IRGACURE 651” photoinitiator from BASF Corporation, Florham Park, New Jersey), and 0.75 part of 2-propylimidazole (obtained under trade designation “ACTIRON NXJ-60 LIQUID” from Synthron, Morganton, North Carolina).

The cloth backing was coated with 172 g/m² of a phenolic make resin consisting of 52 parts of resole phenolic resin (obtained under trade designation “GP 8339 R-23155B” from Georgia Pacific Chemicals, Atlanta, Georgia), 45 parts of calcium metasilicate (obtained under trade designation “WOLLASTOCOAT” from NYCO Company, Willsboro, NY), and 2.5 parts of water.

Abrasive particles AP2 were applied to the make resin-coated backing via an electrostatic coating device as is known in the art. The coating weight of AP2 was 510.6 g/sqm. Immediately after abrasive particles AP2 were coated onto the backing, coated particles of EX-1 were drop coated onto the backing with a coating weight of 174.6 g/sqm.

The abrasive coated backing was placed in an oven at 90° C. for 1 hour, followed by 90 min at 100° C. to partially cure the make resin. A size resin consisting of 45.76 parts of resole phenolic resin (obtained under trade designation “GP 8339 R-23155B” from Georgia Pacific Chemicals), 4.24 parts of water, 24.13 parts of cryolite (Solvay Fluorides, LLC, Houston, Texas), 24.13 parts calcium metasilicate (obtained under trade designation “WOLLASTOCOAT” from NYCO Company, Willsboro, New York) and 1.75 parts red iron oxide was applied to each strip of backing material at a basis weight of 646 g/m², and the coated strip was placed in an oven at 90° C. for 1 hour, followed by 2 h at 102° C. Then the mixture of PE-6 was applied to each strip of backing material at a basis weight of 576 g/sqm, and the coated strip was placed in an oven at 90° C. for 30 min, followed by 12 h at 102° C., followed by 1 hour at 107° C. After cure, the strip of coated abrasive was converted into a belt as is known in the art.

### Comparative Example 1 (CE-1)

Untreated polyester cloth having a basis weight of 300-400 g/m², obtained under the trade designation “POWERSTRAIT” from Milliken & Company, Spartanburg, South Carolina, was pre-sized at the basis weight of 113 g/m² with a composition consisting of 75 parts epoxy resin (bisphenol A diglycidyl ether, obtained under trade designation “EPON 828” from Resolution Performance Products, Houston, Texas), 10 parts of trimethylolpropane triacrylate (obtained under trade designation “SR351” from Cytec Industrial Inc., Woodland Park, New Jersey), 8 parts of dicyandiamide curing agent (obtained under trade designation “DICYANEX 1400B” from Air Products and Chemicals, Allentown, Pennsylvania), 5 parts of novolac resin (obtained under trade designation “RUTAPHEN 8656” from Momentive Specialty Chemicals Inc., Columbus, Ohio), 1 part of 2,2-dimethoxy-2-phenylacetophenone (obtained under trade designation “IRGACURE 651” photoinitiator from BASF Corporation, Florham Park, New Jersey), and 0.75 part of 2-propylimidazole (obtained under trade designation “ACTIRON NXJ-60 LIQUID” from Synthron, Morganton, North Carolina).

The cloth backing was coated with 170 g/m² of a phenolic make resin consisting of 52 parts of resole phenolic resin (obtained under trade designation “GP 8339 R-23155B” from Georgia Pacific Chemicals, Atlanta, Georgia), 45 parts of calcium metasilicate (obtained under trade designation “WOLLASTOCOAT” from NYCO Company, Willsboro, NY), and 2.5 parts of water.

Abrasive particles AP3 and grade 40 aluminum oxide (obtained under trade designation “Duralum G52” from Washington Mills, Niagara Falls, NY) were applied to the make resin-coated backing via an electrostatic coating device as is known in the art. The coating weight of AP3 was 535 g/sqm, and the coating weight of the grade 40 aluminum oxide was 199 g/sqm.

The abrasive coated backing was placed in an oven at 90° C. for 1 hour, followed by 90 min at 100° C. to partially cure the make resin. A size resin consisting of 45.76 parts of resole phenolic resin (obtained under trade designation “GP 8339 R-23155B” from Georgia Pacific Chemicals), 4.24 parts of water, 24.13 parts of cryolite (Solvay Fluorides, LLC, Houston, Texas), 24.13 parts calcium metasilicate (obtained under trade designation “WOLLASTOCOAT” from NYCO Company, Willsboro, New York) and 1.75 parts red iron oxide was applied to each strip of backing material at a basis weight of 514 g/m², and the coated strip was placed in an oven at 90° C. for 1 hour, followed by 12 h at 102° C. After cure, the strip of coated abrasive was converted into a belt as is known in the art.

TABLE 2
Grinding test total cut (g)

| CE-1 | EX-8 | EX-9 | EX-10 |
|---|---|---|---|
| 346 | 518 | 684 | 765 |

Thus, the present disclosure provides, among other things, grinding aid particles, abrasive articles comprising the grinding aid particles, and methods of making the abrasive articles. Various features and advantages of the present disclosure are set forth in the following claims.

1. A grinding aid particle comprising:
a core particle having a surface, the core particle having a Mohs hardness less than 7; and
a coating on at least a portion of the surface of the core particle, the coating comprising a binder and at least one grinding agent.

2. The grinding aid particle of claim 1, wherein the core particle comprises a plant-based material, nepheline syenite, a metal carbonate, silica, a silicate, a metal sulfate, gypsum, vermiculite, wood flour, aluminum trihydrate, carbon black, a metal sulfite, sulfur, an organic sulfur compound, graphite, wax, polymeric material or combinations thereof.

3. The grinding aid particle of claim 1, wherein the binder comprises at least one of a cross-linkable resin or a non-cross-linkable resin.

4. (canceled)

5. The grinding aid particle of claim 1, wherein the grinding agent comprises an organic halide compound, a halogenated polymeric hydrocarbon, a halide salt, a metallic sulfide, or combinations thereof.

6. The grinding aid particle of claim 1, wherein the grinding agent comprises potassium tetrafluoroborate, cryolite, potassium tetrafluoroaluminate, potassium hexafluorozirconate, calcium fluoride, or combinations thereof.

7. The grinding aid particle of claim 1, wherein the coating comprises two or more grinding agents.

8. (canceled)

9. The grinding aid particle of claim 1, wherein the coating comprises 5-80 wt % grinding agent.

10. (canceled)

11. The grinding aid particle of claim 1, wherein the grinding aid particle has a mean particle size of 0.4 micrometers-15,000 micrometers.

12. The grinding aid particle of claim 1, wherein the coating completely encapsulates the core particle.

13. The grinding aid particle of claim 1, wherein the particle comprises at least two coatings and each coating comprises a different grinding agent.

14. A coated abrasive article comprising:
a backing having a first side and a second side;
a make coat overlying the first side of the backing;
a plurality of abrasive particles at least partially embedded in the make coat;
an optional size coat overlying the make coat and abrasive particles; and
a plurality of the grinding aid particles according to claim 1.

15. The coated abrasive article of claim 14, wherein the article comprises the size coat and further comprises a supersize coat overlying the size coat.

16-17. (canceled)

18. The coated abrasive article of claim 15, wherein the plurality of grinding aid particles is dispersed in the make coat, the size coat, the supersize coat, or combinations thereof.

19. The coated abrasive article of claim 14, wherein the plurality of the grinding aid particles comprises a first set of grinding aid particles comprising a first grinding agent and a second set of grinding aid particles comprising a second grinding agent, where the first and second grinding agents are different.

20. The coated abrasive article of claim 19, wherein the first set of grinding aid particles are dispersed in the make coat and the second set of grinding aid particles are dispersed in the size coat.

21. The coated abrasive article of claim 14, wherein the backing comprises polymeric films, fabrics, paper, meshes, scrims, non-woven materials, vulcanized fiber, treated versions thereof, or combinations thereof.

22. The coated abrasive article of claim 14, wherein the mean particle size of the plurality of grinding aid particles is less than the mean particle size of the plurality of abrasive particles.

23. The coated abrasive article of claim 14, further comprising an attachment layer overlying the second side of the backing, the attachment layer comprising a pressure sensitive adhesive, a loop fabric, a hook attachment or combinations thereof.

24. A method of making an abrasive article comprising:
providing a backing having a first side and a second side;
applying a make coat precursor comprising a first curable binder onto the first side of the backing;
applying abrasive particles to the make coat precursor;
applying the grinding aid particles according to claim 1 to the make coat precursor; and
at least partially curing the make coat precursor containing the abrasive particles and grinding aid particles;
wherein applying the abrasive particles and grinding aid particles to the make coat precursor can occur sequentially, in any order, or simultaneously.

25. The method of claim 24 wherein the make coat precursor is partially cured, the method further comprising:
applying a size coat precursor comprising a second curable binder to the partially cured make coat precursor; and
curing the partially cured make coat precursor and size coat precursor.

26. (canceled)
